(19) United States
(12) Patent Application Publication
(10) Pub. No.: US 2020/0091534 A1
(43) Pub. Date: Mar. 19, 2020

(54) PREASSEMBLY OF ELEMENTS FOR MANUFACTURING A MEMBRANE / ELECTRODE ASSEMBLY

(71) Applicant: COMMISSARIAT À L'ENERGIE ATOMIQUE ET AUX ENERGIES ALTERNATIVES, PARIS (FR)

(72) Inventors: Pierrick BUVAT, MONTBAZON (FR); Stéphane CARRIERE, VILLANDRY (FR); Claude BONNIN, TRUYES (FR); Jérôme SERRE, PERTUIS (FR); Paul NGUYEN, TRETS (FR)

(21) Appl. No.: 16/610,573

(22) PCT Filed: May 3, 2018
(86) PCT No.: PCT/FR2018/051110

§ 371 Date: Nov. 4, 2019

(30) Foreign Application Priority Data
May 3, 2017 (FR) 1753913

(51) Int. Cl. H01M 8/1004; H01M 8/0273

(52) U.S. Cl. CPC H01M 8/1004; H01M 2008/1095; H01M 8/0273

(57) ABSTRACT

The invention relates to a method for manufacturing a polymer electrolyte membrane/fuel cell electrode assembly consisting in assembling a reinforcing membrane with a polymer electrolyte membrane at a temperature higher than a subsequent handling temperature of said assembly thus formed.

### FIELD OF THE INVENTION

The present invention relates to a method for securing the layers of a fuel cell membranes assembly.

### TECHNICAL BACKGROUND

Proton exchange membrane fuel cells, known as PEMFCs, stand for “proton exchange membrane fuel cells” or “polymer electrolyte membrane fuel cells” and have particularly interesting compactness properties. Each cell includes a polymer electrolyte membrane that enables only the passage of protons and not the passage of electrons. The membrane is contacted with an anode on a first side and with a cathode on a second side to form a membrane/electrode assembly called MEA.

The above assembly is generally carried out by successive superposition of the different membranes and electrodes with an interposition of reinforcing membranes to support the assembly. In order to secure the different thicknesses together, it is possible to carry out a thermocompression operation of the assembly.

In practice, it can be seen that the superposition of the reinforcing membrane and the polymer electrolyte membrane can be difficult. Indeed, to carry out the assembling, it may be desirable to pre-assemble one of the first reinforcing membrane and the second reinforcing membrane with the polymer electrolyte membrane to facilitate the handling of the polymer electrolyte membrane and the centering of the different membranes with each other. However, it appears that the polymer electrolyte membrane is very sensitive to the humidity variations resulting from temperature variations, the pressure being constant

### SUMMARY OF THE INVENTION

This invention first of all relates to a method for manufacturing a polymer electrolyte membrane/electrode assembly for fuel cells comprising the following steps:
a) provide a reinforcing membrane with an outer edge and an inner edge defining an opening,
b) provide a polymer electrolyte membrane capable of sealing said opening of the reinforcing membrane,
c) the polymer electrolyte membrane and the reinforcing membrane being under first conditions of temperature and humidity:
   c1) superimpose the polymer electrolyte membrane and the reinforcing membrane so that the polymer electrolyte membrane seals the opening of the reinforcing membrane, then
   c2) secure the polymer electrolyte membrane to the reinforcing membrane,
d) place the assembly formed at the end of step c) on a support under second conditions of temperature and humidity such that the polymer electrolyte membrane expands compared to its condition under the first conditions of temperature and humidity.

According to the invention, the pre-assembling of the polymer electrolyte membrane is carried out under first temperature conditions and handled under second temperature and humidity conditions in which the membrane is capable of expansion. In this way, it can be ensured that the polymer electrolyte membrane does not contract as long as the pre-assembly is subjected to the second temperature and humidity conditions. In practice, when the pressure is the atmospheric pressure and the humidity of the air is constant, step c) is performed at a temperature T1 higher than the temperature T2 to which the pre-assembly is subjected when placed on a support.

This support can be that of a storage magazine for the reinforcing membrane polymer electrolyte membrane assembly or the static support of a press that is arranged opposite a piston of said press.

In the first case, it is thus possible to guarantee the flatness of the pre-assembly of the reinforcing membrane with the polymer electrolyte membrane, which makes it easier to grip this pre-assembly, particularly by a suction frame. In addition, the guarantee of the flatness of the pre-assembly makes it easier to stack the other layers of the polymer electrolyte membrane/electrode assembly one on top of the other.

In one particular embodiment of the invention, step d) may include the following steps:
i) placing the reinforcing membrane in an enclosure subject to the first conditions of temperature and humidity,
ii) arranging a polymer electrolyte membrane above the reinforcing membrane so as to seal the opening of the reinforcing membrane;
iii) cutting the polymer electrolyte membrane so that its outer edge is inscribed between the inner and outer edges of the reinforcing membrane,
iv) securing the reinforcing membrane with the polymer electrolyte membrane.

According to yet another characteristic of the invention, steps (iii) and (iv) include the realization, for example using a laser beam, of a first closed welding contour of the polymer electrolyte membrane with the reinforcing membrane and a second closed welding contour of the polymer electrolyte membrane with the reinforcing membrane and cutting only the polymer electrolyte membrane, the second contour surrounding the first contour.

In another embodiment, steps iii) and iv) include the realization of a closed contour of the polymer electrolyte membrane welding with the reinforcing membrane and simultaneously cutting the polymer electrolyte membrane.

In a particular embodiment of the invention, the temperature of the first temperature and humidity conditions is 5 to 50° C. higher than the temperature of the second temperature and humidity conditions, preferably between 10 and 20° C., the humidity being substantially identical under the first and second conditions.

According to another characteristic, the method also includes the following steps:
provide another reinforcing membrane with an outer edge and an inner edge defining an opening,
provide two electrodes each capable of sealing the openings of the reinforcing membranes, p1 arrange the reinforcing membranes, electrodes and polymer electrolyte membrane so as to obtain a successive stacking of one electrode of a reinforcing membrane, the polymer electrolyte membrane, another reinforcing membrane and another electrode, the openings of the reinforcing membranes being sealed by the electrodes and the polymer electrolyte membrane.

The invention will be better understood and other details, characteristics and advantages of the invention will appear when reading the following description, which is given as a non-limiting example, with reference to the attached drawings.

### BRIEF DESCRIPTION OF THE FIGURES

FIG. 1 is a schematic illustration of a first type of electrode—polymer electrolyte membrane—electrode assembly;

FIG. 2 is a schematic view of a pre-assembly of membranes obtained according to the method of the invention;

FIG. 3 is a schematic cross-sectional view of a device intended to be used for the pre-assembly of membranes in FIG. 2;

FIG. 4 is a schematic top view of the device of FIG. 3;

### DETAILED DESCRIPTION

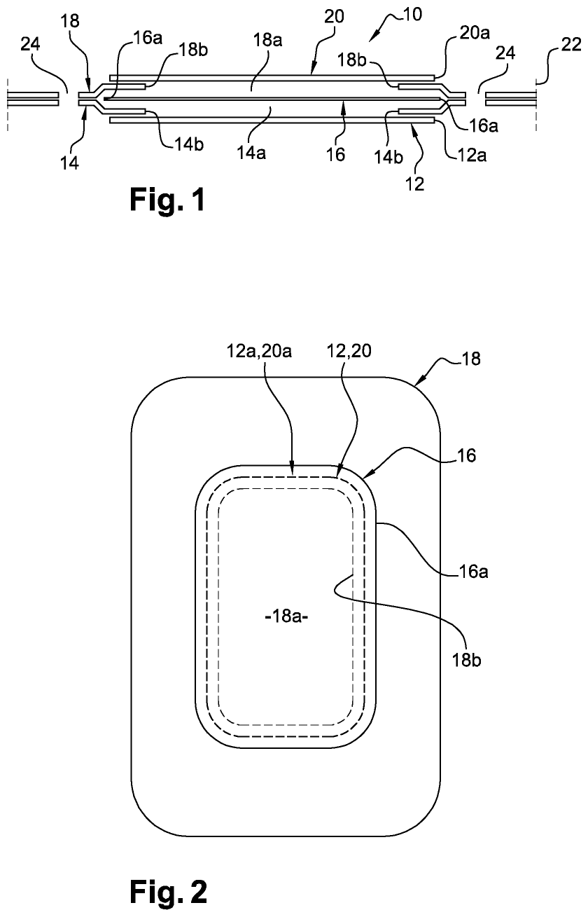

First of all, reference is made to FIG. 1, which represents a polymer electrolyte membrane/electrodes assembly 10 called MEA, comprising the successive elements from bottom to top:
a first electrode 12 or lower electrode capable of forming an anode in a fuel cell,
a first membrane 14 or lower reinforcing membrane comprising an inner edge 14b defining an opening 14a sealed at the bottom by the first electrode 12, the outer edge 12a of the first electrode 12 being in contact with the inner edge 14b of the first reinforcing membrane 14,
a polymer electrolyte membrane 16 ensuring proton conduction,
a second membrane 18 or upper reinforcing membrane comprising an inner edge 18b defining an opening 18a,
a second electrode 20 or upper electrode capable of forming a cathode in a fuel cell and at the top sealing the opening 18a of the upper reinforcing membrane 18, the outer edge 20a of the second electrode 20 being in contact with the inner edge 18b of the second reinforcing membrane 18.

It should be understood that in FIG. 1, the different layers mentioned above are in contact with each other and that the gaps between said layers do not exist in a real assembly. As can be clearly seen in this figure, the polymer electrolyte membrane 16 has an outer edge 16a which is applied:
at the top on the inner edge 14b of the first reinforcing membrane 14 so as to seal its opening 14a at the top,
at the bottom on the inner edge 18b of the second reinforcing membrane 18 so as to seal its opening 18a at the top.

Thus, the polymer electrolyte membrane 16 is completely fitted between the first 14 and second 18 reinforced membranes and thus insulates the polymer electrolyte membrane from the cooling liquid and pure gas passages. This type of assembly is known as “anti-wicking”. More precisely, the assembly presented in FIG. 1 includes a closed contour peripheral cutout 22 forming an outer contour of the electrolyte membrane—electrodes—reinforcing membranes assembly 10. The assembly 10 also includes holes 24 between said peripheral cutout 22 and the outer edge 16a of the polymer electrolyte membrane 16, these holes 24 being intended for the passage of cooling liquid and pure gases (H₂ and O₂ or air). In other words, these holes 24 are formed in a peripheral zone surrounding the polymer electrolyte membrane 16 and the first 12 and second 20 electrodes.

The different layers, namely the first 14 and second 18 reinforcing membranes, the first 12 and second 20 electrodes and the polymer electrolyte membrane 16 can have a substantially rectangular shape. The openings 24 of the first 14 and second 18 reinforcing membranes can also be rectangular in shape. The polymer electrolyte membrane 16 has a larger surface area than the first electrode 12 and the second electrode 20.

FIG. 2 is now referred to as a pre-assembly of the polymer electrolyte membrane 16 with the second reinforcing membrane 18, i. e. with the upper reinforcing membrane. It should be noted that the pre-assembly as described below is also applicable to the first reinforcing membrane 14 or lower reinforcing membrane.

As can be seen in FIG. 2, the second reinforcing membrane 18 is shown here without holes 24, which are made after the assembly and securing of the different layers of the MEA. The first 12 and second 20 electrodes are also shown in dotted lines to show the respective dimensions of the electrodes 12, 20 relative to the polymer electrolyte membrane 16.

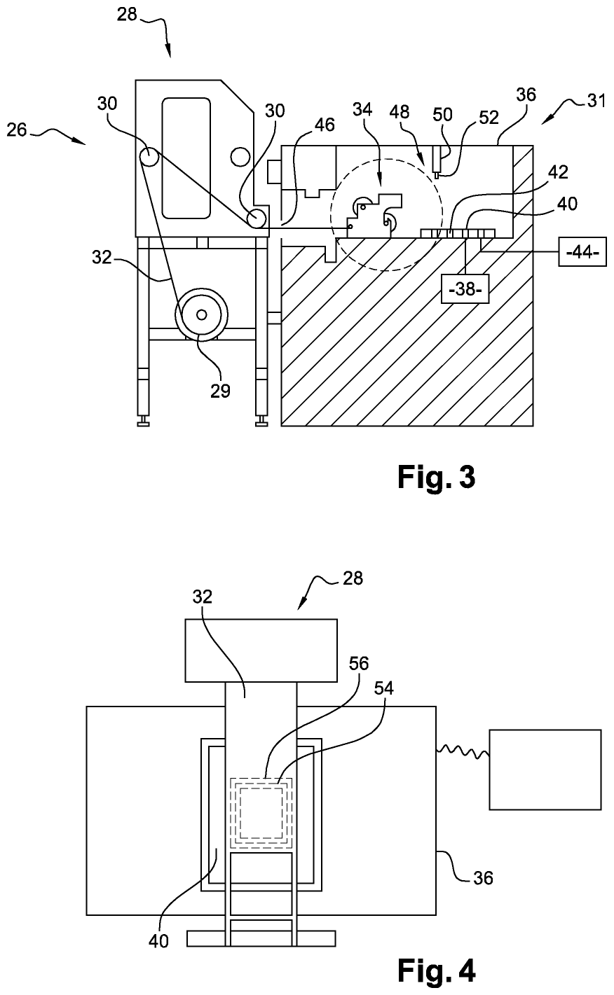

According to the invention, the polymer electrolyte membrane 16 is secured to the second reinforcing membrane 18 by means of the device 26 shown in FIGS. 3 and 4. This device 26 includes an unwinder station 28 of a reel 29 of polymer electrolyte membrane 16 and a heating station 31 and cutting of the polymer electrolyte membrane. This unwinder station 28 includes two axes 30 for running the reel strip. The strip 32 of the reel 30 is formed by a multi-layer structure comprising a layer of polymer electrolyte material covered with a lower protective film and an upper protective film. The station 31 also includes means 34 for separating the lower and upper films, protecting the layer of polymer electrolyte material and winding the lower and upper films. These separation and collection means 34 are arranged in an enclosure 36 or containment box of welding and cutting means 48. This box 36 also houses a plate connected to a heating system 38 by a heating cord. The plate 40 is preferably provided with a plurality of holes 42 connected to suction means 44. The box 36 is provided with a slot 46 formed on one of the side walls so as to allow the circulation of the strip 32 of the reel 30 arranged outside the box 36.

The welding and cutting means 48 arranged inside the box 36. These means 48 include an arm 50 movable in a plane parallel to the plane of the tray 40 which is movable along a vertical axis, i. e. perpendicular to the plane of movement of the arm 50. The arm 50 carries a laser 52 capable of emitting a beam towards the tray.

The method according to the invention includes the following steps: An operator places a reinforcing membrane, namely the second reinforcing membrane 14 on the plate 40. In a second step, the operator pulls on the reel strip in order to cover the opening 18a of the second reinforcing membrane 18. The suction means 44 are then put into operation in order to maintain the second reinforcing membrane 18 and the polymer electrolyte membrane 16 on the plate 40. In a subsequent step, the polymer electrolyte membrane 16 is cut into a substantially rectangular shape and attached to the second reinforcing membrane 18.

The polymer electrolyte membrane 16 is cut and attached to the second reinforcing membrane 18 using laser welding. First, the two layers are secured together by making a first closed contour 54 of the polymer electrolyte membrane 16 welding to the inner edge 18b of the second reinforcing membrane 18. In a second step, a second closed contour 56 of the polymer electrolyte membrane 16 welding is made on the inner edge 18b of the second reinforcing membrane 18, the second contour 58 surrounding the first contour 54. The power of laser when making the first welding contour 54 is such that it allows the polymer electrolyte membrane 16 to be secured to the second reinforcing membrane 18 without cutting it. The realization of the second contour 56 is sufficient to allow a welding of the polymer electrolytic membrane 16 on the second reinforcing membrane 18 while allowing a cutting of the electrolytic membrane 16 only, i. e. without cutting the second reinforcing membrane. It should be noted that a single closed contour 54 could also be used to weld the electrolyte membrane with the reinforcing membrane and cut the polymer electrolyte membrane simultaneously.

Inside the box 36, the polymer electrolyte membrane 16 and the second reinforcing membrane 18 are subjected to first conditions of temperature and humidity. For air with a substantially constant absolute humidity, it is possible to vary the relative humidity or degree of hygrometry by varying the temperature. For a closed air volume, the decrease in relative humidity is obtained by increasing the temperature. Thus, to vary the degree of humidity to which the polymer electrolyte membrane 16 is subjected, it is sufficient to vary the temperature. To this end, the temperature of the enclosure or box 36 and more particularly that of the plate is maintained at a temperature T1 higher than a temperature T2 at which the polymer electrolyte membrane will be handled together with the second reinforcing membrane 18 to which it is secured.

In a particular embodiment of the invention, the temperature of the first temperature and humidity conditions is 5 to 50° C. higher than the temperature of the second temperature and humidity conditions, preferably between 10 and 20° C., the humidity being substantially identical under the first and second conditions.

The realization of the polymer electrolyte membrane—second reinforcing membrane assembly at a temperature higher than that at which said assembly is then handled—allows the membrane when subjected to temperature T2 relative to its state at temperature T1. Thus, the polymer electrolyte membrane, which is highly sensitive to moisture variations, does not induce any stress on the second reinforcing membrane 18, which can thus be kept in a flat state for subsequent assembly with the first 12 and second 20 electrodes and the first reinforcing membrane 14.

For example, for reference ambient air with a relative humidity (RH) of 50% at 20° C., the housing can be regulated to a temperature of 35° C. In this case, the air is locally at 22% relative humidity. The thinness of the membranes (10-50 μm) makes it possible to consider that the temperature rise time of the polymer electrolyte membrane 16 and the water stabilisation time of the polymer electrolyte membrane 16 are less than the positioning and initialization time of the welding/cutting cycle.

At 35° C. 22% RH, the membrane initially at 20° C. 50% RH undergoes a thermal expansion of 0.5% and a “water” shrinkage of 7.8%, i.e. an overall shrinkage of 7.3%. After welding and cutting the membrane, the double layer thus formed is returned to ambient condition and the polymer electrolyte membrane 16 undergoes a reverse deformation (expansion) of 7.3%. Consequently, the membrane does not generate any stress on the reinforcement to which it is secured.

Similarly, the placement of the polymer electrolyte membrane 16 secured to the second reinforcing membrane 18 in the environment of the MEA machine, in particular on a static support of a press that is 25° C. and therefore at 38% RH, will cause a new deformation of the membrane but limited to:
0.2% thermal expansion
3.4% “water” withdrawal
That is an overall withdrawal of 3.2%.

Since the polymer electrolyte membrane 16 is expanded by 7.3%, a shrinkage of 3.2% will not generate any stress on the reinforcing membrane, which will therefore remain perfectly positioned on the press support. This reasoning also applies to the handling of the polymer electrolyte membrane 16—second reinforcing membrane 18 double layer which is easier to achieve with a suction frame when said double layer is perfectly flat.

1.-7. (canceled)

8. A method for pre-assembling components of a polymer electrolyte membrane/electrode assembly for fuel cells comprising the following steps:
a) providing a first reinforcing membrane comprising an outer edge and an inner edge defining an opening,
b) providing a polymer electrolyte membrane capable of sealing said opening of the reinforcing membrane,
c) the polymer electrolyte membrane and the first reinforcing membrane being under first conditions of temperature and humidity:
c1) superimposing the polymer electrolyte membrane and the first reinforcing membrane so that the polymer electrolyte membrane seals the opening of the reinforcing membrane, then
c2) connecting the polymer electrolyte membrane to the first reinforcing membrane,
d) placing the assembly formed at the end of step c) on a support under second temperature and humidity conditions such that the polymer electrolyte membrane expands compared to its state under the first temperature and humidity conditions.

9. A method according to claim 8, wherein the support is that of a storage magazine of the first reinforcing membrane—polymer electrolyte membrane assembly or the static support of a press which is arranged opposite a piston of said press.

10. A method according to claim 8, wherein step d) comprises the following steps:
i) placing the first reinforcing membrane in an enclosure subjected to the first temperature and humidity conditions,
ii) arranging a polymer electrolyte membrane above the first reinforcing membrane so as to seal the opening of the reinforcing membrane;
iii) cutting the polymer electrolyte membrane so that its outer edge is inscribed between the inner edge and the outer edge of the first reinforcing membrane,
iv) securing the first reinforcing membrane with the polymer electrolyte membrane.

11. A method according to claim 9, wherein step d) comprises the following steps:
i) placing the first reinforcing membrane in an enclosure subjected to the first temperature and humidity conditions,
ii) arranging a polymer electrolyte membrane above the first reinforcing membrane so as to seal the opening of the reinforcing membrane;
iii) cutting the polymer electrolyte membrane so that its outer edge is inscribed between the inner edge and the outer edge of the first reinforcing membrane,
iv) securing the first reinforcing membrane with the polymer electrolyte membrane.

12. A method according to claim 10, wherein steps iii) and iv) comprise the realization of a closed contour of the polymer electrolyte membrane welding with the first reinforcing membrane and simultaneously cutting the polymer electrolyte membrane.

13. A method according to claim 10, wherein steps iii) and iv) are carried out using a laser beam.

14. A method according to claim 12, wherein steps iii) and iv) are carried out using a laser beam.

15. A method according to claim 8, wherein the temperature of the first temperature and humidity conditions is 5 to 50° C. higher than the temperature of the second temperature and humidity conditions, preferably between 10 and 20° C., humidity being substantially the same under the first and second conditions.

16. A method according to claim 9, wherein the temperature of the first temperature and humidity conditions is 5 to 50° C. higher than the temperature of the second temperature and humidity conditions, preferably between 10 and 20° C., humidity being substantially the same under the first and second conditions.

17. A method according to claim 10, wherein the temperature of the first temperature and humidity conditions is 5 to 50° C. higher than the temperature of the second temperature and humidity conditions, preferably between 10 and 20° C., humidity being substantially the same under the first and second conditions.

18. A method according to claim 12, wherein the temperature of the first temperature and humidity conditions is 5 to 50° C. higher than the temperature of the second temperature and humidity conditions, preferably between 10 and 20° C., humidity being substantially the same under the first and second conditions.

19. The method according to claim 8, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.

20. The method according to claim 9, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.

21. The method according to claim 10, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.

22. The method according to claim 12, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.

23. The method according to claim 13, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.

24. The method according to claim 15, wherein it comprises the following steps:
providing a second reinforcing membrane comprising an outer edge and an inner edge defining an opening,
providing first and second electrodes each capable of sealing the openings of the first and second reinforcing membranes,
arranging the first and second reinforcing membranes, the first and second electrodes and the polymer electrolyte membrane so as to obtain a successive stacking of the first electrode, the first reinforcing membrane, the polymer electrolyte membrane, the second reinforcing membrane and the second electrode, the openings of the first and second reinforcing membranes being sealed by the first and second electrodes and the polymer electrolyte membrane.
